(19) United States
(12) Patent Application Publication
(10) Pub. No.: US 2016/0055424 A1
(43) Pub. Date: Feb. 25, 2016

(54) INTELLIGENT HORIZON SCANNING

(71) Applicant: INTERNATIONAL BUSINESS MACHINES CORPORATION, Armonk, NY (US)

(72) Inventors: Jayant R. Kalagnanam, Tarrytown, NY (US); Kiran Appasaheb Kate, The Madeira (SG); Andy Purnama Prapanca, Singapore (SG)

(21) Appl. No.: 14/502,414

(22) Filed: Sep. 30, 2014

Related U.S. Application Data
(60) Provisional application No. 62/040,726, filed on Aug. 22, 2014.

(51) Int. Cl. G06N 99/00; G06N 5/04

(52) U.S. Cl. CPC G06N 99/005; G06N 5/045

(57) ABSTRACT

A method and computer program product and tool for increasing efficiency of an intelligent horizon scanning process. The horizon scanning process methodology uses a set of negative training examples, a universum data set of articles, and a data subset of unlabeled instances from received positive class and unlabeled electronic documents. Further a ranking model that can use partial pairwise preferences is implemented to generate a list of recommended articles for output to a user.

### CROSS REFERENCE TO RELATED APPLICATIONS

The present invention claims benefit of U.S. provisional patent application 62/040,726 filed Aug. 22, 2014, the entire content and disclosure of which is incorporated by reference.

### BACKGROUND

The present invention relates generally to information retrieving tools, and particularly tools implementing machine learning methods and systems for retrieving information and providing a recommendation to an organization, business or enterprise based on the retrieved content.

Horizon scanning is an important and critical step in many organizations today. Generally, “Horizon Scanning” is ill-defined and used differently by various actors. In a narrow sense, it refers to a policy tool that systematically gathers a broad range of information about emerging issues and trends in an organization's political, economic, social, technological, or ecological environment.” In one aspect: Horizon scanning is used to perform an “Information function”, i.e., informing policy-makers about emerging trends and developments in an organization's external environment.

With an overload of information on the internet, it is becoming increasingly difficult to access important and relevant information, e.g., from web-pages.

### SUMMARY

A information retrieval tool implementing a system and method for performing intelligent horizon scanning using machine learning methods. The tool implements novel methods for each of the intelligent horizon scanning steps.

In one aspect, there is provided a method for intelligent horizon scanning. The method comprises: accessing web-based electronic documents, the documents including positive class and unlabeled electronic documents; generating a training dataset of a negative class from the positive class documents; generating a universum dataset; and generating an unlabeled data subset; classifying positive articles based on the training dataset, universum dataset and unlabeled data subset, and ranking the classified positive documents articles, wherein a programmed hardware processor device performs the accessing, the training dataset, universum dataset and unlabeled data subset generating, classifying and ranking steps.

In a further aspect, there is provided a tool for intelligent horizon scanning comprising: a memory storage device; a programmed hardware processor device coupled with the memory, the hardware processor device configured for: accessing web-based electronic documents, the documents including positive class and unlabeled electronic documents; generating a training dataset of a negative class from the positive class documents; generating a universum dataset; and generating an unlabeled data subset; classifying positive articles based on the training dataset, universum dataset and unlabeled data subset, and ranking the classified positive documents articles.

A computer program product is provided for performing operations. The computer program product includes a storage medium readable by a processing circuit and storing instructions run by the processing circuit for running a method. The storage medium readable by a processing circuit is not only a propagating signal. The method is the same as listed above.

### BRIEF DESCRIPTION OF THE SEVERAL VIEWS OF THE DRAWINGS

FIG. 1 generally depicts a system implementing the overall horizon scanning process according to one embodiment;

FIG. 2 generally depicts the overall horizon scanning process according to one embodiment;

FIG. 3 is a flow chart depicting a method involved in creating negative class training dataset from positive sample;

FIG. 4 is a flow chart depicting the steps involved in generating a universum dataset;

FIG. 5 is a flow chart depicting a method for selecting unlabeled instances for semi-supervised learning;

FIG. 6 shows an example ranked document list 60 output generated on a display device;

FIG. 7 shows results of rigorous experiments conducted to demonstrate the increased accuracy and efficiency using the horizon scanning methodology described herein; and

FIG. 8 illustrates one embodiment of an exemplary hardware configuration of a computing system programmed to perform the method steps described herein.

### DETAILED DESCRIPTION

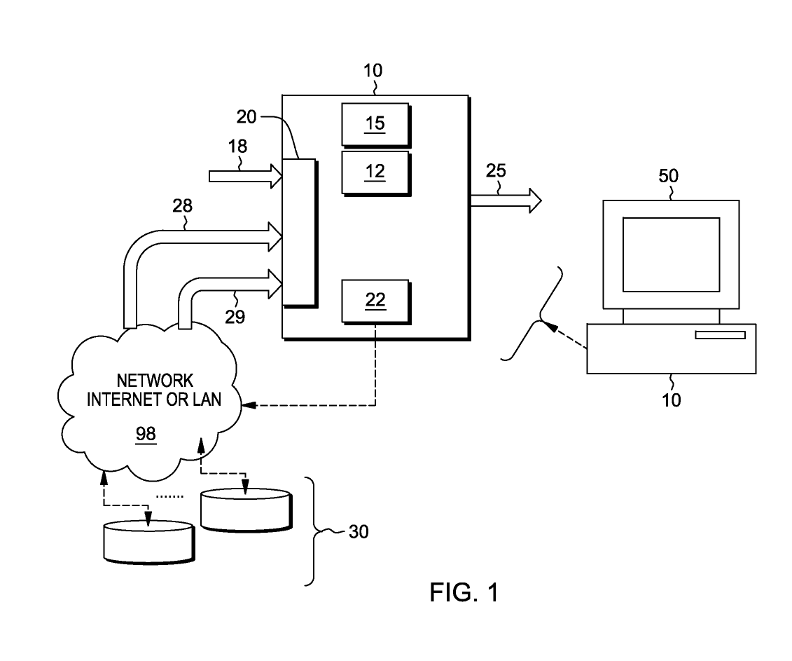

In one embodiment, as shown in FIG. 1, an apparatus includes a computer system 10 having a memory 12 and a hardware processor device 15 coupled to a memory that is configured to execute computer program code to perform the methodologies for horizon scanning as described herein.

As shown, the hardware processor 15 is provided or receives inputs including a set of positive class documents (or articles) 28 and unlabeled articles 29 obtained from web-based data repositories or content sources 30 such as available via a network 98 such as the Internet. The processor 15 may, in one embodiment, receive from the memory 12 or from an external source (such as another computer system via a network interface 20) a list 18 of data sources. In one embodiment, the processor 15 runs software to configure itself as a web crawler 22 to crawl the list of data sources 18.

Alternately, computer system 10 may initiate another web crawler component to crawl a list of data sources 18 and obtain positive class documents (or articles) 28 and unlabeled articles 29.

In one embodiment, document inputs 28, 29 may be or include an organization's internally stored documents that can be obtained from a local or remote repository through a network via other mechanisms such as internal APIs (application programming interfaces), webservices etc.

In one embodiment, unlabeled articles 29 may be documents (e.g., web-pages, electronic journals, electronic documents, etc.) having one or more of: unstructured data or content or semi-structured data or content (e.g., obtained from the web) including unlabeled, i.e., unclassified articles. These are processed (scanned) by the processor 15 and the processor, running horizon scanning methodologies described herein, generates an expected output including a list of articles. In one embodiment, these articles are ranked by relevance that is a recommended reading for users. The processor 10 generates output signals 25 representing the list of ranked articles (documents) for presentation via a display device 50.

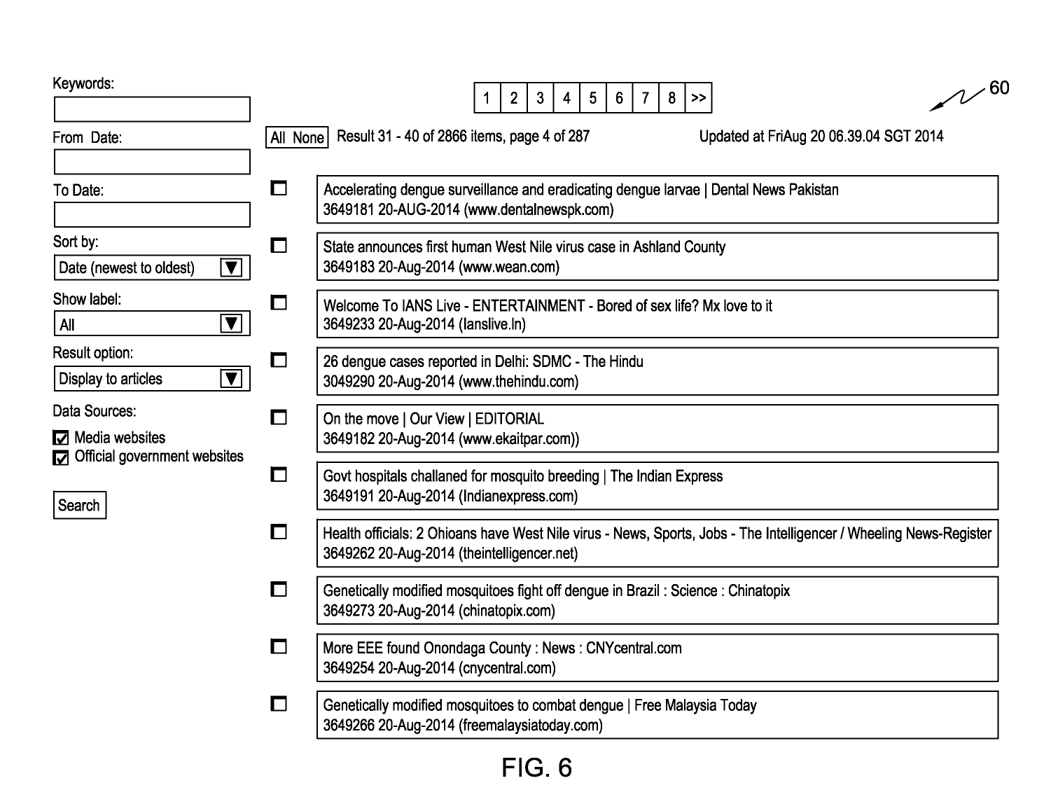

As shown in FIG. 6, the generated output signals may be configured as a display of a ranked list such as the example and non-limiting list 60 formatted on a webpage. In a further embodiment, the generated output signals 25 may be configured to be presented to a user as a list via an e-mail message.

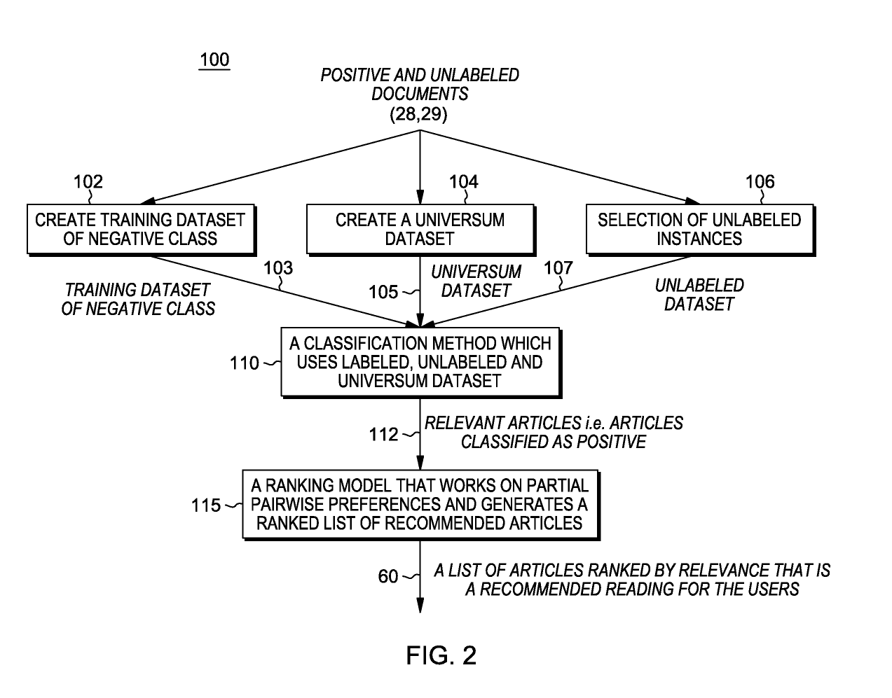

FIG. 2 shows a flow chart depicting the overall horizon scanning process 100 implemented by computing system 10. As part of the implemented process, the method implemented includes steps 102 for generating a set of negative training examples 103, steps 104 for generating a universum data set 105 of articles, and steps 106 for generating a data subset of unlabeled instances 107 from received positive class and unlabeled documents 28, 29. As shown, the method steps 102, 104 and 106 may be performed in parallel using techniques described herein below.

Then at 110, the next method step includes classifying the articles as positive articles 112 by implementing a semi-supervised learning technique that uses all three datasets 103, 105, 107 for classification. The method then performs a step 115 of passing the classification results 112 through a ranking model that can use partial pairwise preferences to come up with a final ranking of the articles. This final ranking is output to a user, such as displaying the list 60 or communicating this final ranked article list in a form useful by a user. In one embodiment, a RankSVM method (an application of support vector machine) may be implemented. As known, ranking SVM, is one pair-wise ranking method which is used to adaptively sort web-pages by their relationships (how relevant) to a specific query. A mapping function is required to define such relationship. The mapping function projects each data pair (e.g., inquire and clicked web-page) onto a feature space. These features combined with user's click-through data (which implies page ranks for a specific query) can be considered as the training data for machine learning algorithms. Generally, Ranking SVM includes three steps in the training period: 1) It maps the similarities between queries and the clicked pages onto certain feature space. 2) It calculates the distances between any two of the vectors obtained in step 1; and 3) It forms optimization problem which is similar to SVM classification and solve such problem with the regular SVM solver. It is understood that there are many other ranking models that could be implemented.

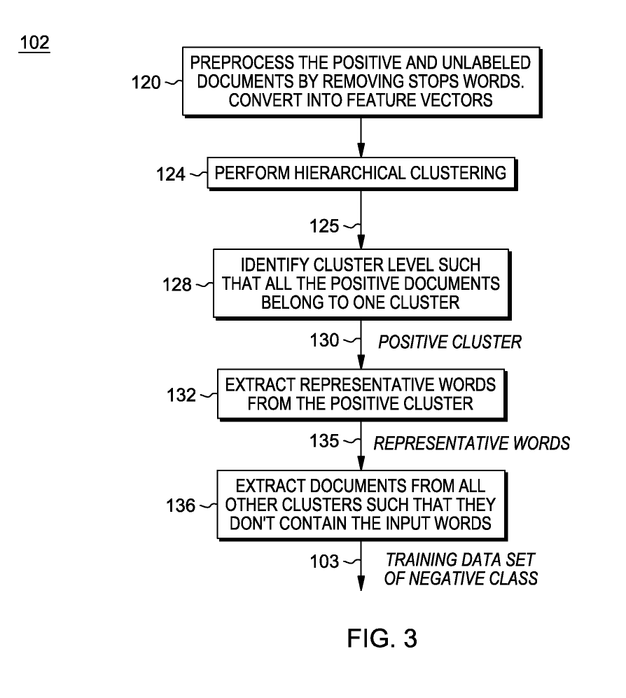

FIG. 3 shows a flow chart depicting in greater detail the method steps 102 (of FIG. 2) for generating a negative training dataset 103 from training examples of positive class alone. In many applications, it might be possible to obtain labeled data for one class, mostly positive class. But the negative examples are not available from the domain experts. There are two options in which this may be handled:
1. Applying one class classification models; or
2. Obtaining negative class samples by random sampling from the unlabeled dataset.

The next method then automatically generates negative samples for such a case such that it uses all the information available in the best possible manner. As shown in FIG. 3, following steps are performed to generate a good training set of negative samples 103: First the processor is configured to run a step 124 to perform hierarchical clustering (i.e., a clustering method using known algorithm that builds a hierarchy of clusters) on the positive class and unlabeled dataset. In one embodiment, at a first or preprocessing step 120, the processor performs identifying and removing “stop” words from the positive and unlabeled articles (documents 28, 29) and converting the articles into corresponding feature vectors. The stop word removal and article to feature vector conversion steps are performed prior to performing the hierarchical clustering 124. The output 125 of the hierarchical clustering step is in the form of a dendrogram 125 tree-like structure. The method then performs, at 128, taking a cut at the dendrogram where all the positive samples belong to the same cluster. That is, a process is implemented to identify certain clusters represented at a particular level of the tree to work with. Thus, there is identified a cluster level such that all positive articles belong to one cluster for output (positive cluster) 130. In one embodiment, a next step 132 includes extracting representative words from the positive cluster. This step may include: identifying representative words 135 from this cluster, such as by: identifying a top k amount of words by frequency of occurrence, or identifying a top k topics and identifying words from the top k topics. Then, using the representative words 135, there if performed at 136 identifying documents from clusters other than the positive cluster such that they do not contain any of the representative words identified in the previous step 132. The document set identified at step 136 is treated as a negative training sample or a training data set of negative class 103.

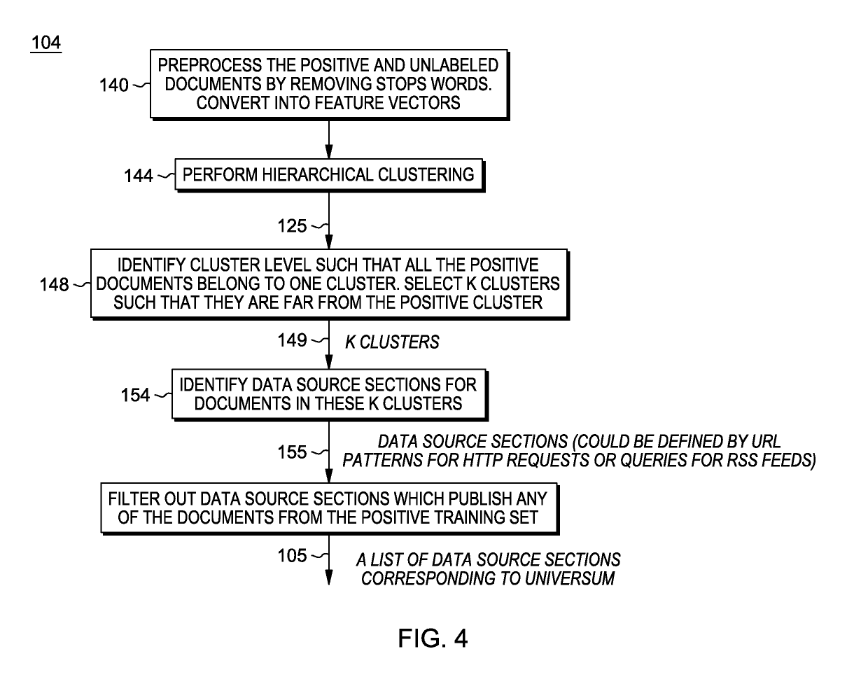

FIG. 4 shows a flow chart depicting in greater detail the method steps 104 (of FIG. 2) for generating a universum data set of articles 105. A universum is a collection of “non-examples” that do not belong to either class of interest. This collection allows one to encode prior knowledge by representing meaningful concepts in the same domain as the problem at hand. (See for example, J. Weston, R. Collobert, F. H. Sinz, L. Bottou, and V. Vapnik. “Inference with the universum.” In ICML, pages 1009-1016, 2006 incorporated by reference herein.)

The method 104 provides for automatically identifying sections of the data sources (e.g., websites, journals, etc.) which are very unlikely to contain relevant documents and hence can be used as universum. In one embodiment, feedback from “experts” may be solicited and taken on these sections, in which experts are asked to identify those for which they are highly confident of not being relevant to their information needs, and hence can be considered as universum for the underlying classification problem.

As shown in FIG. 4, following steps are performed to generate a universum data set of articles 105: A step 140 performs a first or preprocessing step for removing “stop” words from the positive and unlabeled articles (documents) and converting the articles into corresponding feature vectors. Then, at 144 there is performed a hierarchical clustering on the positive + unlabeled dataset to obtain the dendrogram 125 tree-like structure as described above.

The method then performs, at 148, taking a cut at the dendrogram where all the positive samples belong to the same cluster. That is, the cluster level is identified such that all positive articles belong to one cluster (positive cluster). Method step 148 further performs identifying a top K clusters in descending order of their distance from the positive cluster, i.e., selecting K clusters 149 such that they are far from the positive cluster. Then at 154, there is performed identifying data source sections 155 for the documents in these selected K clusters. Generally, data source sections may include different sections of a website. In one embodiment, identification of a data source section of the documents in the K clusters may include: identifying, for example, url patterns for http://requests (e.g., like “xyznews.com/news/health”) or queries for RSS (Really Simple Syndication) feeds corresponding to documents from these top K clusters. For example, a typical news website may have “sections” such as politics, business, sports, technology, etc. Since the inputs refer to web articles from these sections, they are unstructured content. Thus, the “data source sections” references are indicating an association of the section names with the articles that are used. This set of articles is referred to herein as set “S”. Then, at 156, there is performed filtering out data source sections which publish in any of the documents in these K clusters, i.e., filtering out sections from S which publish any positive class documents. Thus, based on the defined data source sections, for example, if one of the documents from the positive training set was obtained by crawling a section such as News->technology, then “news->technology” will be removed from the data source sections set “S”. This set of documents (list of data source sections) published at S is treated as a Universum data set 105.

As mentioned, in one embodiment, there may be further performed: recommending the set S of documents having identified data source sections to one or more experts; obtaining a feedback or comments on whether any of those documents is likely to publish any relevant content; and filtering out documents from the set S which have non zero probability of publishing relevant content based on the obtained expert feedback.

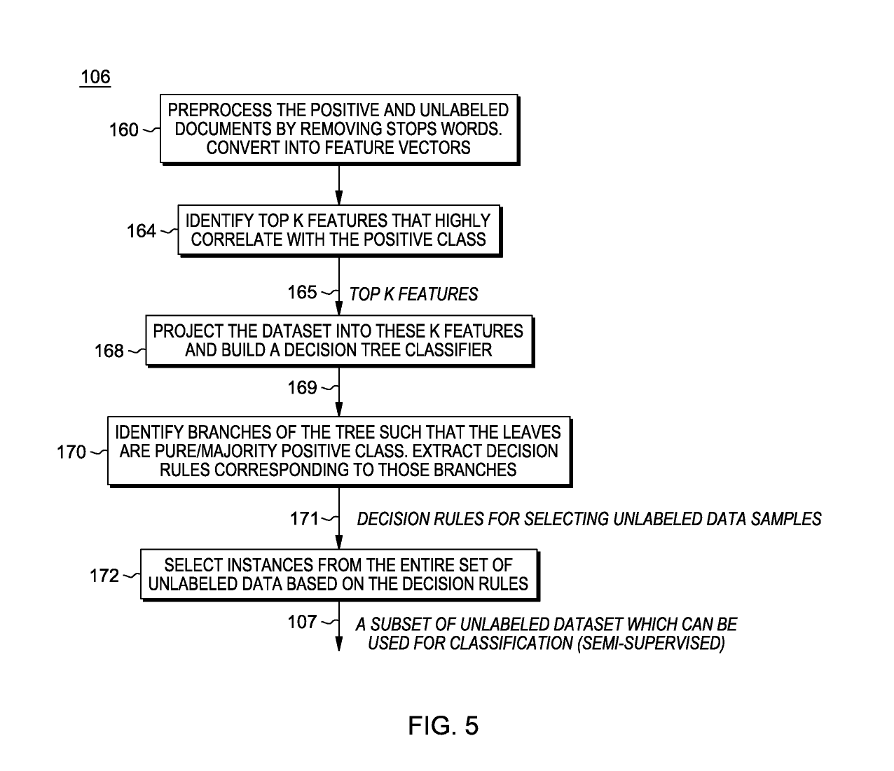

FIG. 5 shows a flow chart depicting in greater detail the method steps 106 (of FIG. 2) for selecting unlabeled instances. More particularly, FIG. 5 outlines method steps for constructing an unlabeled dataset 107 that is to be used in the semi-supervised approach for classification of documents. These steps include: at 160, a first or preprocessing step for removing “stop” words from the positive and unlabeled articles (documents) and converting the articles into corresponding feature vectors. Then, at 164 there is performed identifying the top K features 165 from the dataset which highly correlate with the positive class. Then, at 168 there is performed constructing a decision tree 169 from the dataset after selecting only those top K features. In one embodiment, decision tree construction includes projecting the dataset into these K features for use in building a decision tree classifier. In one embodiment, the decision tree (classification tree or regression tree) 169 is used as a predictive model for mapping observations about an item to conclusions about the item's target value. It is a predictive modeling approach used in machine learning. In the tree structures, leaves represent class labels and branches represent conjunctions of features that lead to those class labels.

Then at 170, the method includes identifying branches of the tree corresponding to leaves with pure/majority positive class. Identification of branches means following through decision rules along a branch of a tree. Those branches are treated as rules to select samples from the entire set of unlabeled data. This includes, extracting the decision rules 171 corresponding to those branches. Finally, at 172 the method includes selecting instances from the entire set of unlabeled data based on the decision rules. That is, the data points selected in the previous step 170 are used as unlabeled dataset for classification, e.g., by semi-supervised learning. In one embodiment, there may be uses a 3-class semi-supervised support vector machine as described in Haiqin Yang, Shenghuo Zhu, Irwin King, and Michael R. Lyu. “Can irrelevant data help semi-supervised learning, why and how?” In Proceedings of the 20th ACM International Conference on Information and Knowledge Management, CIKM '11, pages 937-946, 2011 the teachings of which are incorporated by reference as if fully set forth herein. It is understood that other classification methods may work that can use positive, negative labeled data, unlabeled data and universum.

This method of selecting unlabeled instances is biased towards positive class and works well for the horizon scanning setting since high recall is more important and the non-relevant documents can come from a variety of topics distributions—making the superset unlabeled data very noisy.

Thus, the system and methods described provides effective intelligent horizon scanning by using document classification and ranking techniques including: the method for automatic selection of negative class samples is based on samples of a positive class; the use of explicit universum obtained by exploiting the web site structure improves document classification; and the use of unlabeled instances selection, e.g., a “Meta” attribute driven controlled selection of unlabeled instances. Moreover, employment of a ranking model that works on determined partial pairwise preferences to generate the ranked list coupled with explicit user feedback further improves classification. Further use may be made of applying learning to rank methods to improve ranking accuracy.

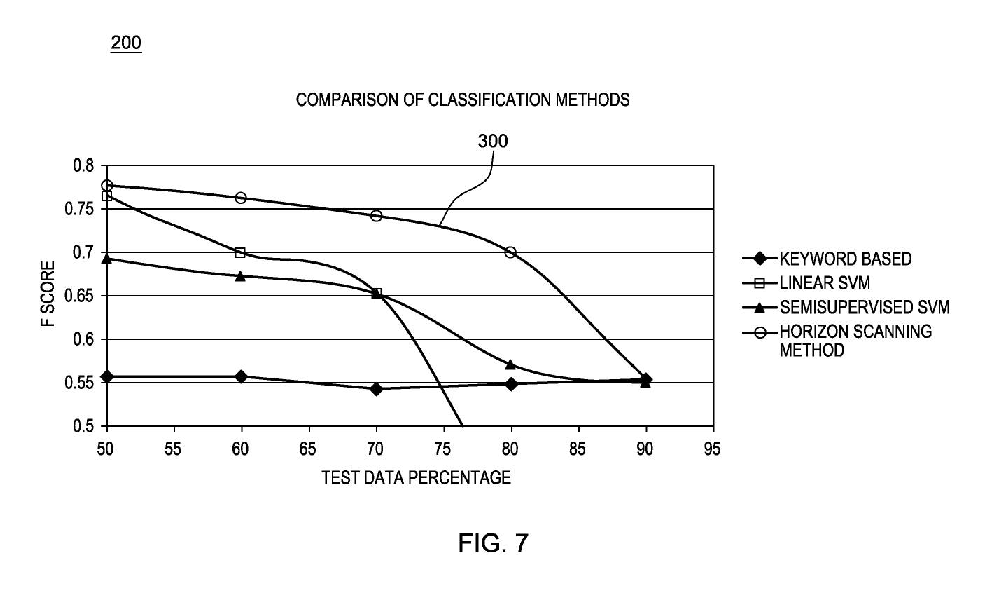

The combination of universum data, unlabeled instances selection and ranking improves the performance significantly. FIG. 7 shows results 200 of rigorous experiments conducted to demonstrate that the horizon scanning methodology 100 herein using a set of negative training examples 103, a universum data set 105 of articles, and a data subset of unlabeled instances 107 from received positive class and unlabeled documents and the ranking model works better than the traditional approaches such as keyword based, linear SVM, Semisupervised SVM as shown by the higher “F” score or F-measure 300.

The system and methods providing effective intelligent horizon scanning by using document classification and ranking is used by organizations for looking at current information in their area or of their concern and assess future opportunities, risks, etc. The inputs are also used for planning and strategy making. The present system and method herein performs the information gathering part efficiently.

One example use of the horizon scanning techniques used herein is by an enterprise, organization or a government entity, for example. For example, a government may wish to coordinate a government wide information network of agencies covering counterterrorism intelligence, bio-medical and cyber-surveillance, maritime security, and energy security.

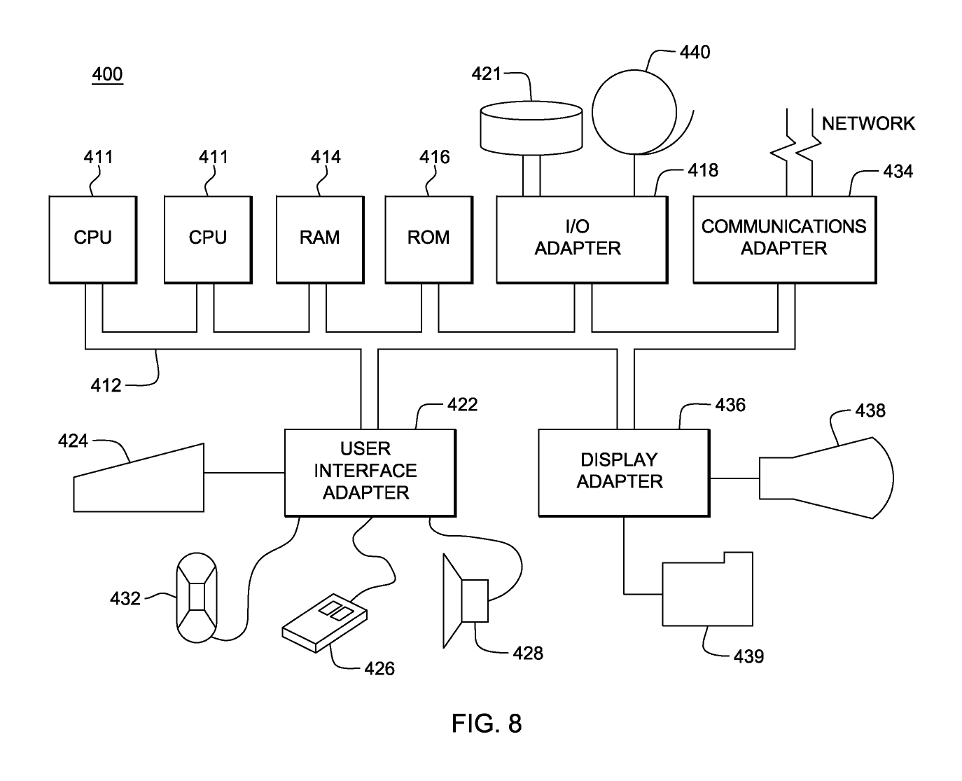

Referring to FIG. 8 illustrates one embodiment of an exemplary hardware configuration of a computing system 400 programmed to perform the method steps described herein with respect to FIGS. 2-5. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for intelligent horizon scanning comprising:
accessing web-based electronic documents, said documents including positive class and unlabeled electronic documents;
generating a training dataset of a negative class from said positive class documents;
generating a universum dataset; and
generating an unlabeled data subset;
classifying positive articles based on said training dataset, universum dataset and unlabeled data subset, and
ranking said classified positive documents articles,
wherein a programmed hardware processor device performs said accessing, said training dataset, universum dataset and unlabeled data subset generating, classifying and ranking steps.

2. The method of claim 1, where the generating a negative class training dataset for training based on the positive class documents comprises:
hierarchically clustering the positive labeled and unlabeled dataset to form a dendrogram data structure;
identifying from the dendrogram data structure all the positive samples belonging to a same positive cluster;
identifying representative words from the positive cluster;
identifying documents from clusters other than the positive cluster such that they do not contain any of the representative words identified,
wherein a document set identified from clusters other than the positive cluster provides said negative class training sample.

3. The method of claim 2, where the generating a universum dataset from said positive class comprises:
identifying a top K clusters in descending order of their distance from the positive cluster;
identifying the data source sections corresponding to documents from the top K clusters, said documents having said identified data source sections labeled as documents S;
filtering out sections from S which publish any positive class documents; and
providing all the documents published at S as said universum.

4. The method of claim 2, wherein the generating an unlabeled dataset from said positive class comprises:
identifying top K features from the dataset which correlate with the positive class, selecting said identified top K features;
constructing a decision tree structure from the dataset after said selecting said top k features;
identifying branches of said decision tree corresponding to leaves with a pure or majority positive class, said branches becoming rules for selecting samples from said data set of unlabeled data.

5. A tool for intelligent horizon scanning comprising:
a memory storage device;
a programmed hardware processor device coupled with said memory, said hardware processor device configured for:
accessing web-based electronic documents, said documents including positive class and unlabeled electronic documents;
generating a training dataset of a negative class from said positive class documents;
generating a universum dataset; and
generating an unlabeled data subset;
classifying positive articles based on said training dataset, universum dataset and unlabeled data subset, and
ranking said classified positive documents articles.

6. The tool of claim 5, where the creating a negative class training sample for training based on a positive class documents comprises:
hierarchically clustering the positive labeled and unlabeled dataset to form a dendrogram data structure;
identifying from the dendrogram data structure all the positive samples belonging to a same positive cluster;
identifying representative words from the positive cluster;
identifying documents from clusters other than the positive cluster such that they do not contain any of the representative words identified,
wherein a document set identified from clusters other than the positive cluster provides said negative class training sample.

7. The tool of claim 6, where the generating a universum dataset from said positive class comprises:
identifying a top K clusters in descending order of their distance from the positive cluster;
identifying the data source sections corresponding to documents from the top K clusters, said documents having said identified data source sections labeled as documents S;
filtering out sections from S which publish any positive class documents; and
providing all the documents published at S as said universum.

8. The tool of claim 7, wherein the generating an unlabeled dataset from said positive class comprises:
identifying top K features from the dataset which correlate with the positive class,
selecting said identified top K features;
constructing a decision tree structure from the dataset after said selecting said top k features;
identifying branches of said decision tree corresponding to leaves with a pure or majority positive class, said branches becoming rules for selecting samples from said data set of unlabeled data.

9. A computer program product for intelligent horizon scanning, the computer program product comprising a computer readable storage medium, the computer readable storage medium excluding a propagating signal, the computer readable storage medium readable by a processing circuit and storing instructions run by the processing circuit for performing a method comprising:
accessing web-based electronic documents, said documents including positive class and unlabeled electronic documents;
generating a training dataset of a negative class from said positive class documents;
generating a universum dataset; and
generating an unlabeled data subset;
classifying positive articles based on said training dataset, universum dataset and unlabeled data subset, and
ranking said classified positive documents articles.

10. The computer program product as claimed in claim 9, where the generating a negative class training dataset for training based on the positive class documents comprises:
hierarchically clustering the positive labeled and unlabeled dataset to form a dendrogram data structure;
identifying from the dendrogram data structure all the positive samples belonging to a same positive cluster;
identifying representative words from the positive cluster;
identifying documents from clusters other than the positive cluster such that they do not contain any of the representative words identified,
wherein a document set identified from clusters other than the positive cluster provides said negative class training sample.

11. The computer program product as claimed in claim 10, where the generating a universum dataset from said positive class comprises:
identifying a top K clusters in descending order of their distance from the positive cluster;
identifying the data source sections corresponding to documents from the top K clusters, said documents having said identified data source sections labeled as documents S;
filtering out sections from S which publish any positive class documents; and
providing all the documents published at S as said universum.

12. The computer program product as claimed in claim 11, wherein the generating an unlabeled dataset from said positive class comprises:
identifying top K features from the dataset which correlate with the positive class,
selecting said identified top K features;
constructing a decision tree structure from the dataset after said selecting said top k features;
identifying branches of said decision tree corresponding to leaves with a pure or majority positive class, said branches becoming rules for selecting samples from said data set of unlabeled data.
